(19) United States
(12) Patent Application Publication
(10) Pub. No.: US 2007/0067328 A1
(43) Pub. Date: Mar. 22, 2007

(54) Method for navigation in a list of elements and audiovisual receiver for the selection of elements in a list

(75) Inventors: Jacques Mingot, Noisy Le Roi (FR); Goulven Querre, Noyal Sur Vilaine (FR); Nicolas Marce, Prestimoneire (FR); Francois Goiset, Janze (FR); Rene Gauthier, Arzon (FR); William Renault, Cesson Sevigne (FR); Nadine Patry, Rennes (FR)

Correspondence Address: THOMSON LICENSING INC., PATENT OPERATIONS, PO BOX 5312, PRINCETON, NJ, 08543-5312, US

(73) Assignee: THOMSON LICENSING, Boulogne-Billancourt (FR)

(21) Appl. No.: 10/557,397

(22) PCT Filed: May 19, 2004
(86) PCT No.: PCT/EP04/50851

§ 371 Date: Sep. 25, 2006

(30) Foreign Application Priority Data
May 20, 2003 (FR) 0306006
Jan. 5, 2004 (FR) 0450005

(51) Int. Cl. G06F 7/00

(52) U.S. Cl. 707/102

(57) ABSTRACT

The invention relates to a method for navigating in a list of items in an audiovisual receiver including a first step for generating an ordered list of items available in the receiver, a step for displaying a first sub-list extracted from the list including a first item highlighted at one end of the displayed sub-list. The method also includes a step for identifying a second item adjacent to the first item not appearing in the first sub-list, and a step for displaying a second sub-list including at least the first item and the second highlighted item. In one improvement to the present invention, the displayed items are digital television service identifiers. In one variant, these items are identifiers of events broadcast by a television network. The invention also relates to the receiver capable of selecting the services according to the method.

The invention relates to a method for navigating in a list of items that can be accessed using an audiovisual receiver, and an audiovisual receiver equipped with a user interface for the selection.

In a television broadcast system, the number of channels available is becoming very large. In the field of digital television, hundreds of services are currently presented in the form of a list displayed on a screen, and the user navigates within this list to select the desired service. The user operates the direction keys to point to a service identified by its name which is then visually marked out from the other services. The services may also be presented as icons, representing the logo for the service. This visual marking out, commonly referred to as “focus”, is generally a change of colour, of the shade of grey or of the contrast compared with the other services. The viewing of the audiovisual content of the service is then commanded by pressing a validation (OK) key. Due to the very large number of services that are accessible, the user must action many navigation commands to eventually place the focus on the desired service and to select it.

French patent application FR 2 805 698, filed by the applicant and published on Aug. 31, 2001, discloses a method for selecting a channel or a service in a displayed list. This patent application discloses the continuous scrolling of items grouped together in a list; the item at the centre of the screen is always the one with the focus, and therefore it is simply a question of waiting until the desired service scrolls and enters this position so that it can be selected and at the same time activated. The item at the centre of the screen is surrounded on all sides by the next and previous items such that the user can easily locate this item in the list. This patent application enables the remote control to be considerably simplified and by the automatic scrolling of services on the screen, the number of commands that the user needs to apply before arriving at the correct service is significantly limited.

It was recently observed that this method for presenting items on a screen confuses some users. Such users remain highly attached to a manual operation in which any change on the screen is caused by a command and do not like to have to constantly pay attention to the screen contents to ensure that they do not miss the desired service on the screen.

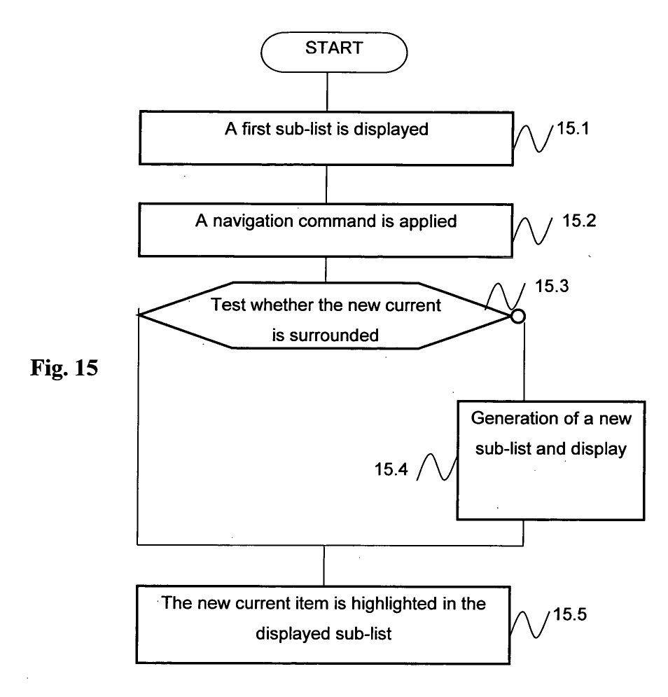

International patent application WO00/59214 published on Oct. 5, 2000 discloses a system for presenting a program guide. The broadcast network offers a large number of services broadcasting audiovisual programs. These services are identified by a name and possibly the program being broadcast. The services are presented in lists appearing vertically on the screen, and the focus is placed on an item in the list. The user can shift the focus using the direction keys on the remote control and thus visually highlight a service in the displayed list. In this way, the user can see part of the list of services broadcast and, by navigating on this part, the user can select a service. However as FIGS. 24, 28 and 32 show, the service in the focus is not always actually located within a displayed list, and this can confuse the user who consequently may navigate in the wrong direction.

Another method consists in displaying one page of a certain number of items extracted from the list. The page is arranged vertically and the direction commands, “up arrow” and “down arrow”, are used to navigate within this page and to shift the focus, while the items in the page do not change position. The user may of course change the displayed page by pressing a “previous page” or “next page” key, or by positioning the focus on the last item at the bottom of the page and by pressing [symbol] , or by positioning the focus on the first item at the top of the page and by pressing [symbol] . When the user uses the [symbol] or [symbol] command, causing a change of page, the item with the focus is at the start or end of the new page. The user would then have difficulty in situating it in the list. If quite a long period of time has elapsed since the previous command, the user would not remember whether the item with the focus is the first in the list (if it is at the top of the page) or the last (if it is at the bottom of the page). Locating an item within the list is not precise; the user does not have a clear understanding of the actual position of the item in the list of items.

The present invention relates to a method for navigating in a list which makes it possible to situate with precision the item that can be selected by the user, and the receiver for selecting an item in this way.

A subject of the present invention is a method for navigating on items displayed on displaying means, including a first step for generating and displaying a first sub-list of items extracted from a list of items, the current sub-list item being highlighted graphically;

characterized in that it includes a second step for generating and displaying a second sub-list of items, said step being activated when, after a navigation command is applied, the new current item is located at the first or last position of the first sub-list, the second sub-list presenting the new current item surrounded by at least two items.

In this way, navigation is achieved through sub-lists displayed on a screen and following the identification of the new item having the focus, that item is visually surrounded by at least two items that can be accessed by each of the available navigation keys. Thus, the user can situate this new item and if necessary return to the previous item which is also displayed.

According to a first improvement, the identification step is triggered by a user command received by the receiver. The latter can thus navigate in any way in the list of items. According to one variant, the steps for identifying and displaying a second sub-list occur after a determined period of time, the items in the list being successively highlighted by the receiver according to the defined order. In that case, it is the receiver that controls the scrolling of items on the screen.

According to another improvement, when the user applies a page jump navigation command, the new current item is located in the same position in the second sub-list as in the first sub-list.

According to another improvement, the sub-lists are displayed with the aid of a grid. When the new current item is located on the edge of the grid of the first sub-list, the second sub-list presents the new item surrounded by at least four items located in the four navigation directions.

According to another improvement, the number of items surrounding the new current item is programmable. According to a last improvement, the displayed items are identifiers of services broadcast by a digital television network.

According to another improvement, the items are identifiers of services broadcast by a digital television network. According to one variant, the items are identifiers of events broadcast by a television network.

According to another improvement, the method includes a step for displaying an indicator associated with displayed services or events, the presence of the indicator indicating that the associated service or event is not broadcast by the same satellite as the currently selected channel. Thus, the user can tell whether selecting the service or event associated with this indicator requires a change of satellite by the activation of a motorized antenna, and therefore a certain period of time to view the selected item. This indicator is presented when, in the configuration for the receiver, the latter has integrated by appropriate means the presence of a motorized antenna.

Another subject of the present invention is an audiovisual terminal including means for applying navigation commands and display means for displaying a first sub-list, graphically highlighting a first item referred to as “current”; characterized in that it includes generation means for generating a second sub-list activated when, after a navigation command is applied, the new current item is located at the first or last position of the first sub-list, the second sub-list displayed by the display means presenting the new current item surrounded by at least two items.

Other features and advantages of the invention will become apparent from the description of a no limiting example embodiment of the invention, explained with reference to the accompanying figures in which:

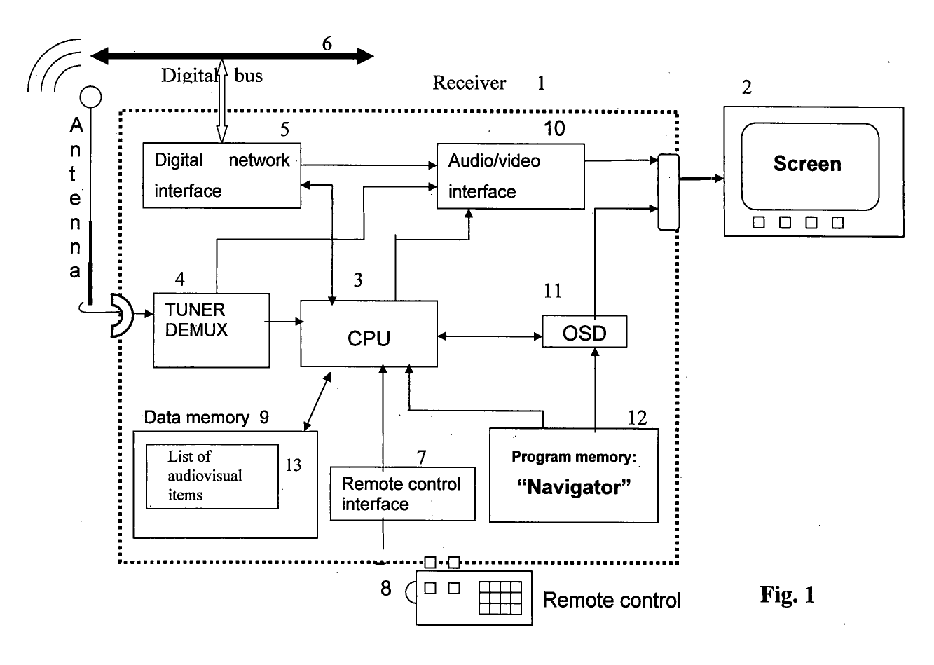

FIG. 1 is a block diagram of a digital television reception system according to an example embodiment;

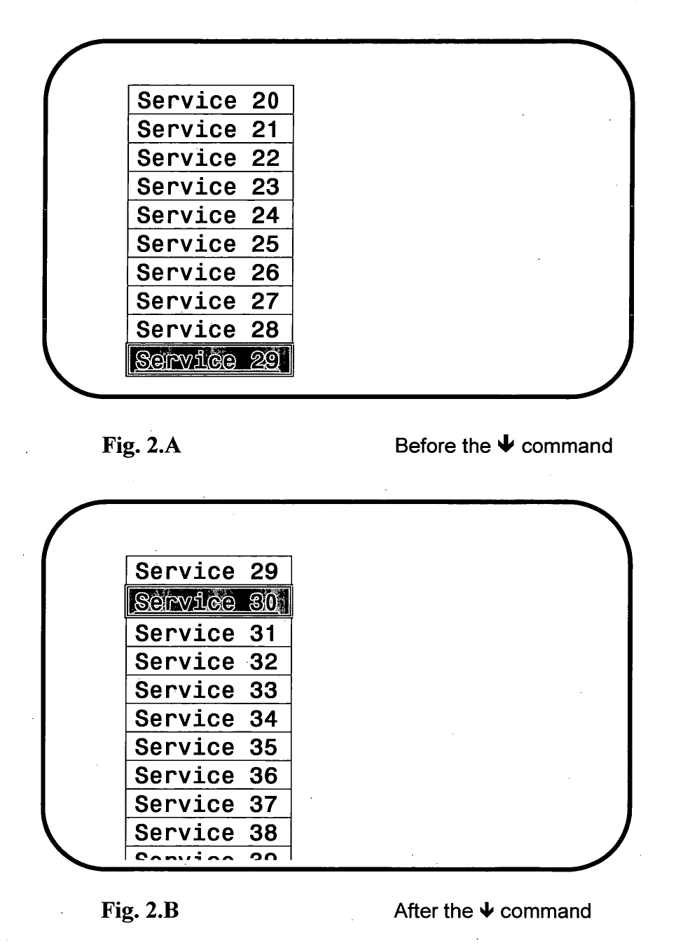

FIG. 2 is an example of a representation on the screen of a user interface page displaying two sub-lists displayed before and after a [symbol] navigation command is executed;

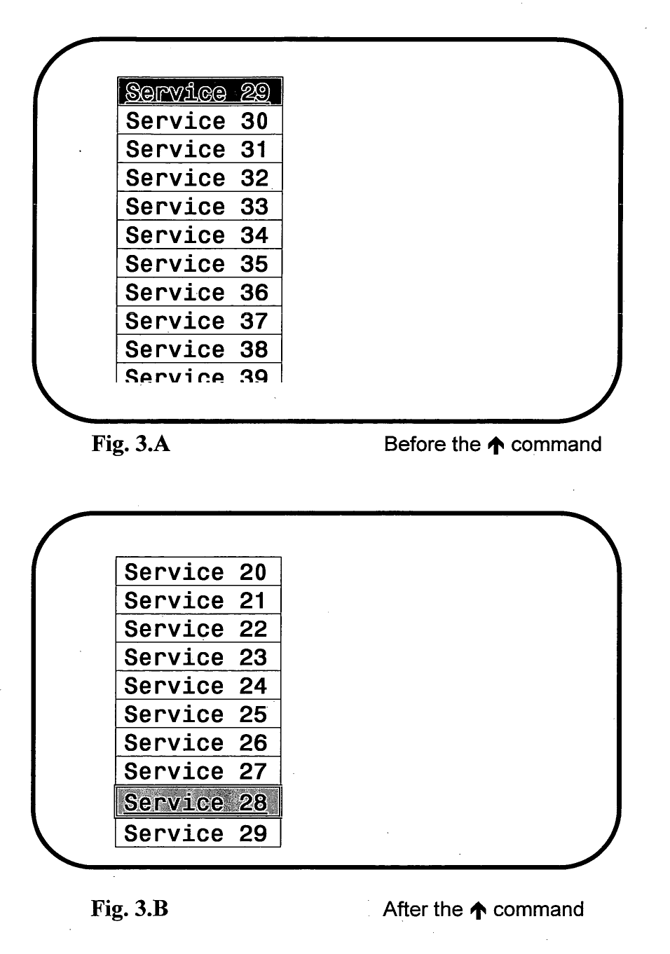

FIG. 3 is an example of how a screen appears following the execution of a [symbol] navigation command and displaying a sub-list of 11 items;

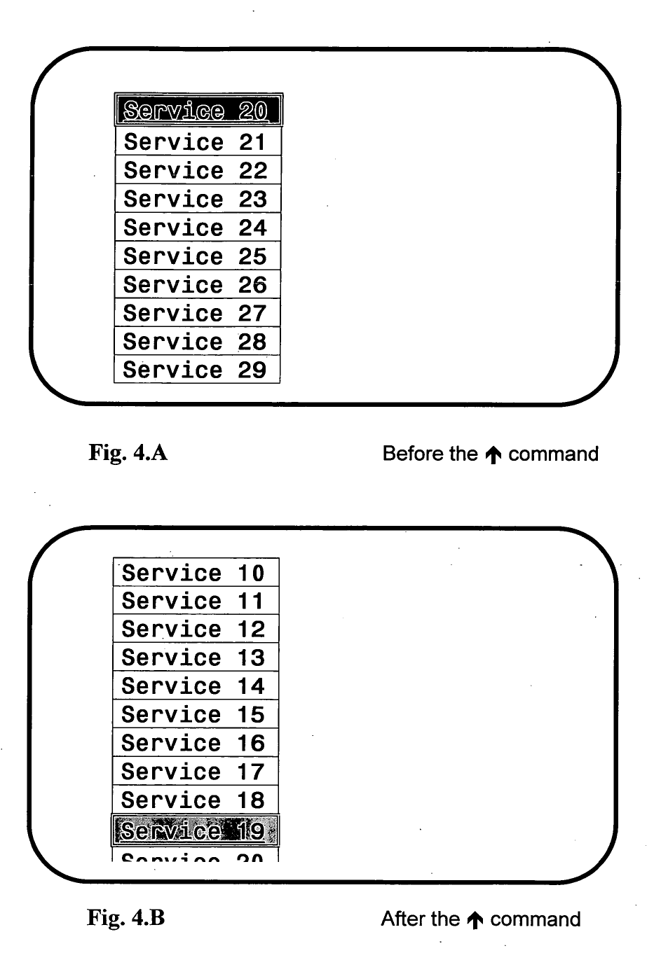

FIG. 4 is an example of how a screen appears following the execution of a [symbol] navigation command, navigating in a page of 10 services;

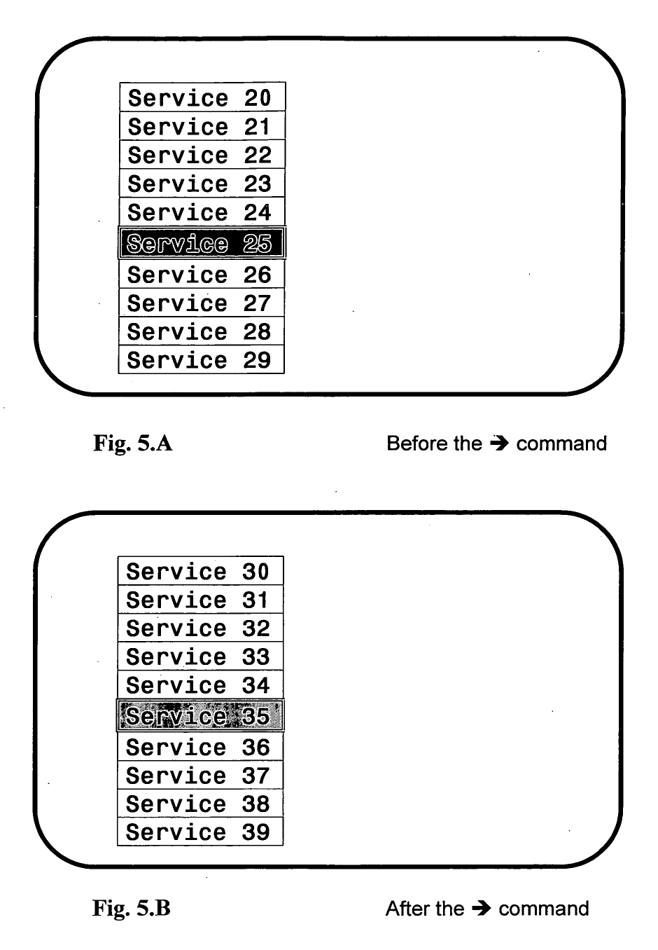

FIG. 5 is an example of how a screen appears following the execution of a [symbol] navigation command to successively view sub-lists of 10 services;

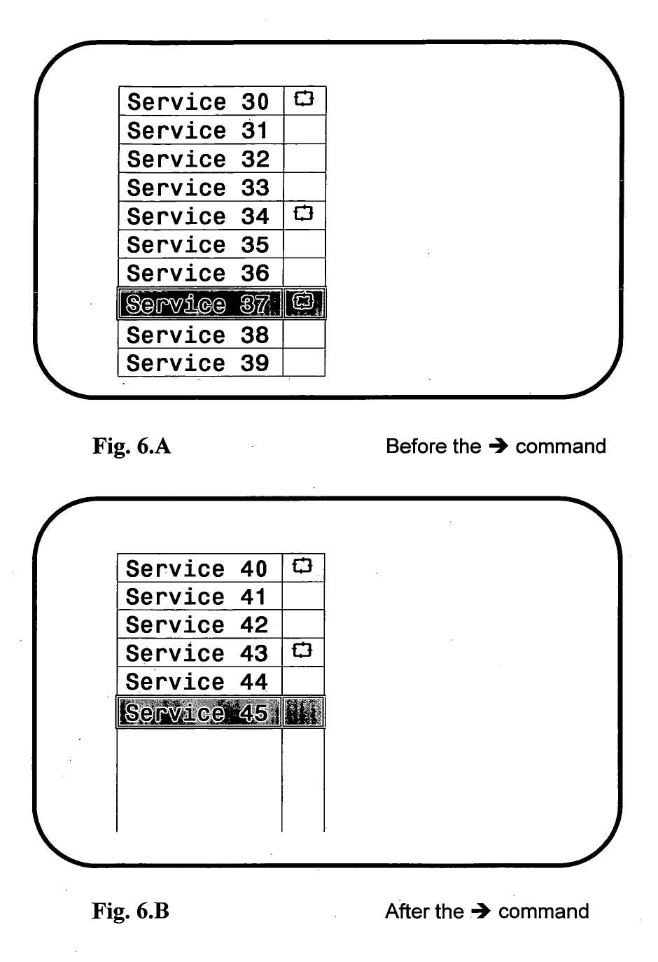

FIG. 6 is an example of how a screen appears following the execution of a [symbol] navigation command when the list limit is reached.

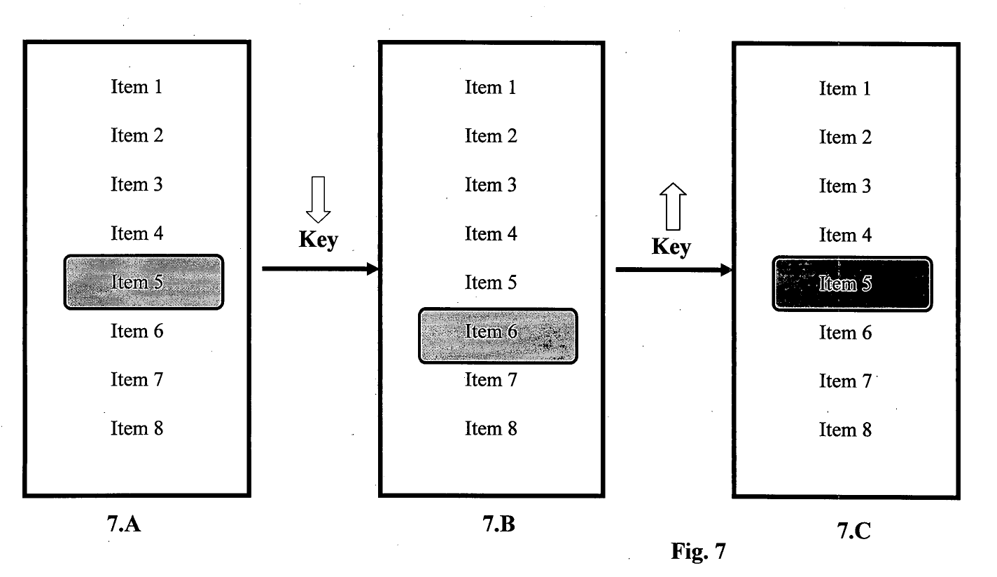

FIG. 7 shows example representations of three screen appearances showing the display of a part of a list following navigation commands and according to the prior art;

FIG. 8 shows example representations. of three screen appearances showing the display of a part of a list after [symbol] and [symbol] navigation commands are applied;

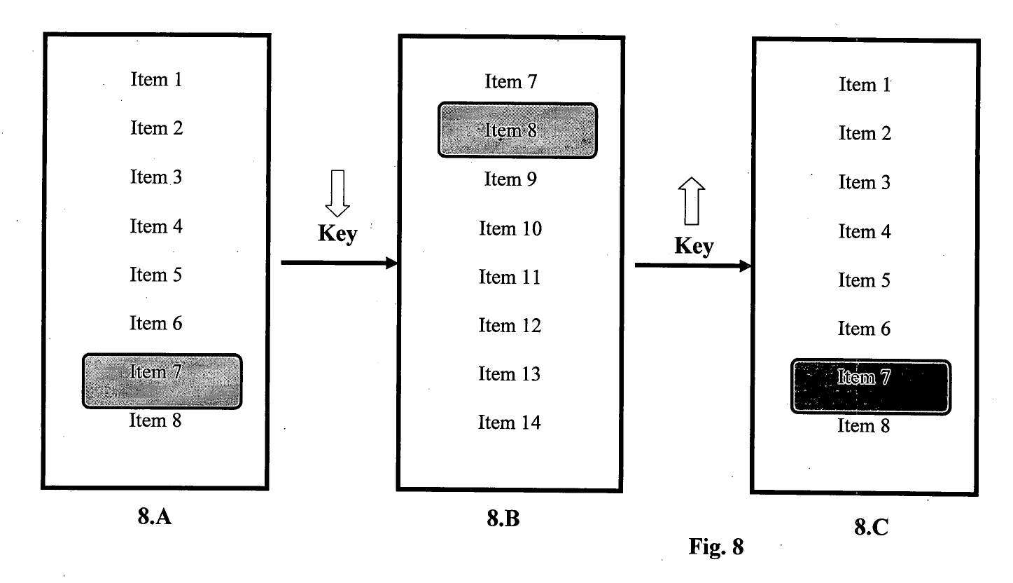

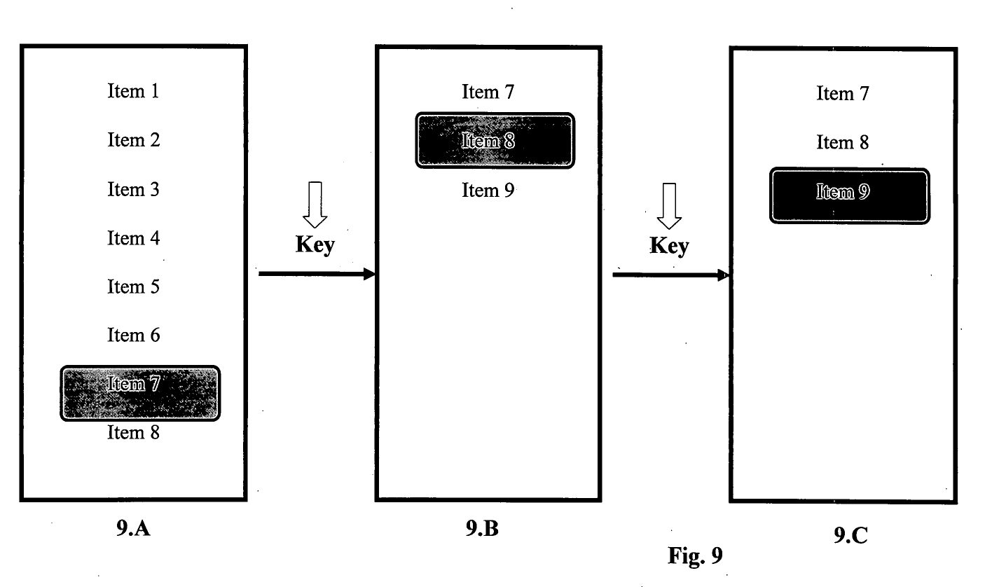

FIG. 9 presents three screen appearances showing the display of a part of a list after [symbol] navigation commands are applied when the end of the list is reached;

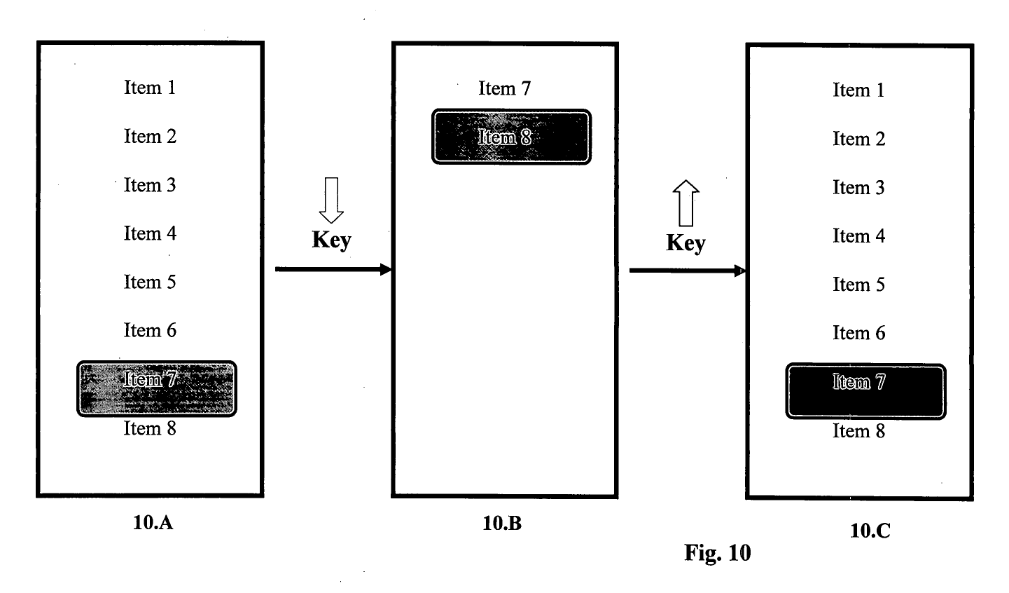

FIG. 10 presents three screen appearances showing the display of a part of a list after [symbol] and [symbol] navigation commands are applied near the end of the list;

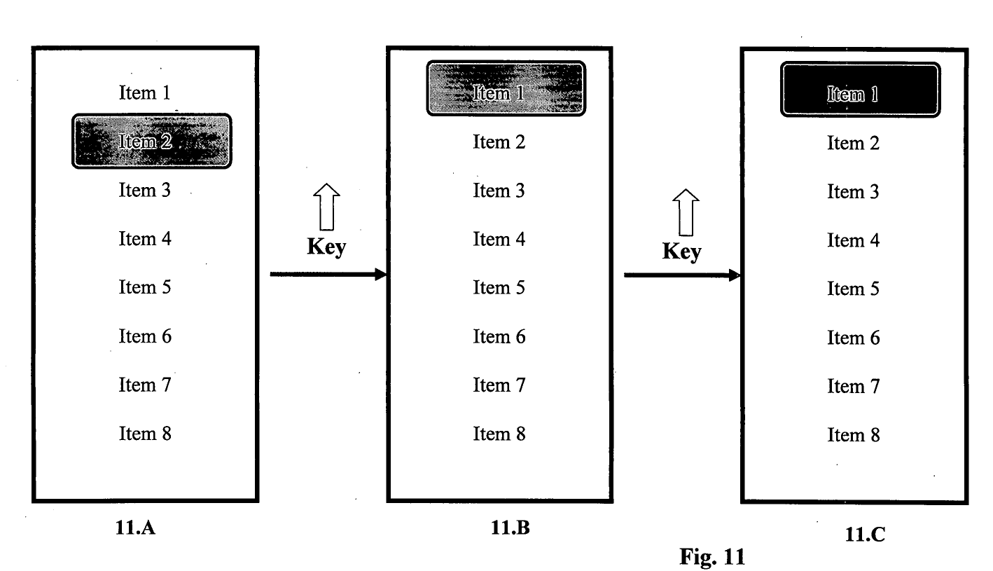

FIG. 11 shows how the focus acts and how the sub-list is displayed after several [symbol] commands are applied when the focus is near the start of the list;

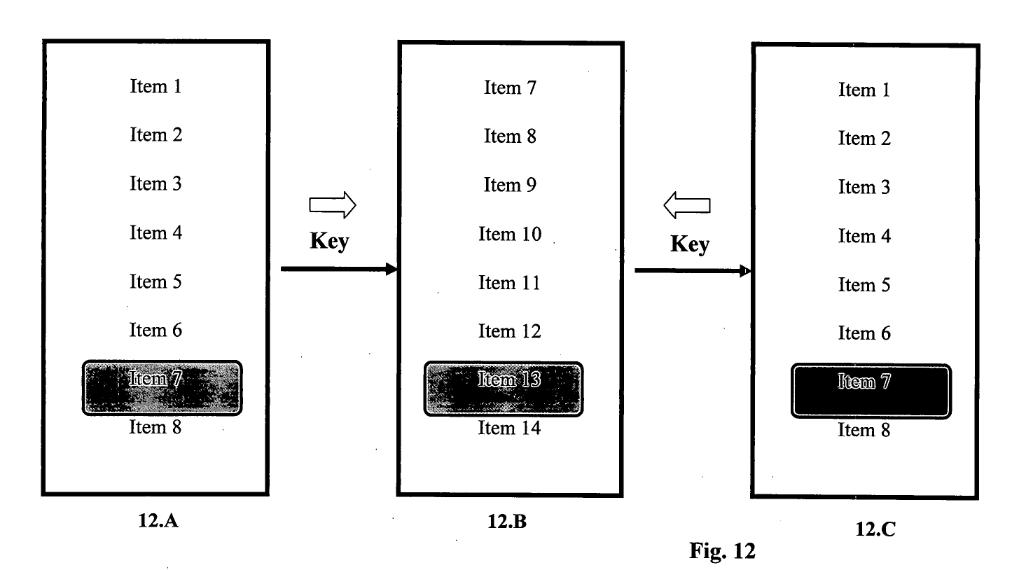

FIG. 12 shows example representations of three screen appearances showing the display of a part of a list after [symbol] and [symbol] navigation commands are applied;

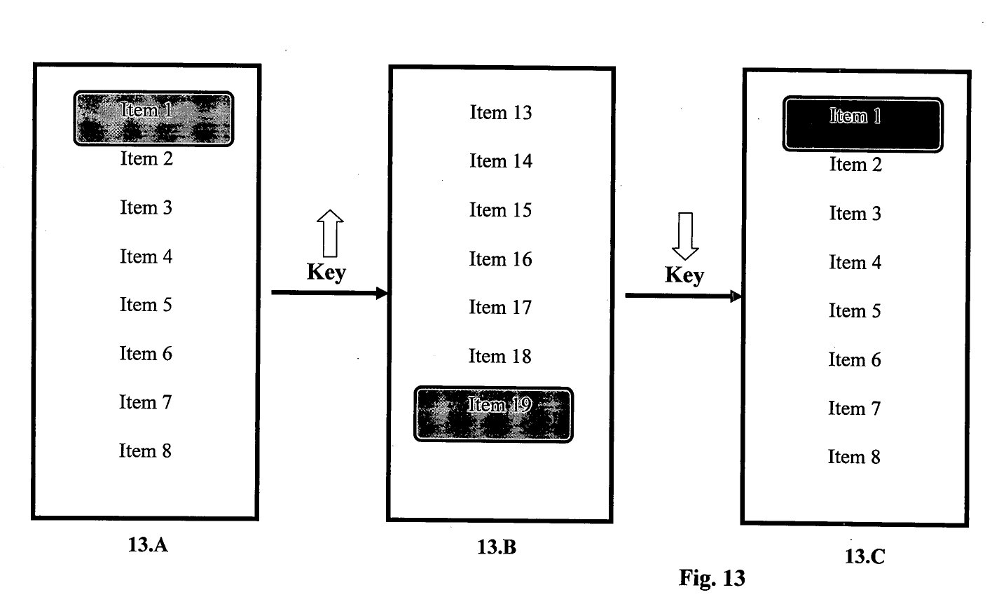

FIG. 13 shows an alternative way for the focus to act and for the sub-list to be displayed after [symbol] and [symbol] commands are applied when the item in the focus is near the start of the list;

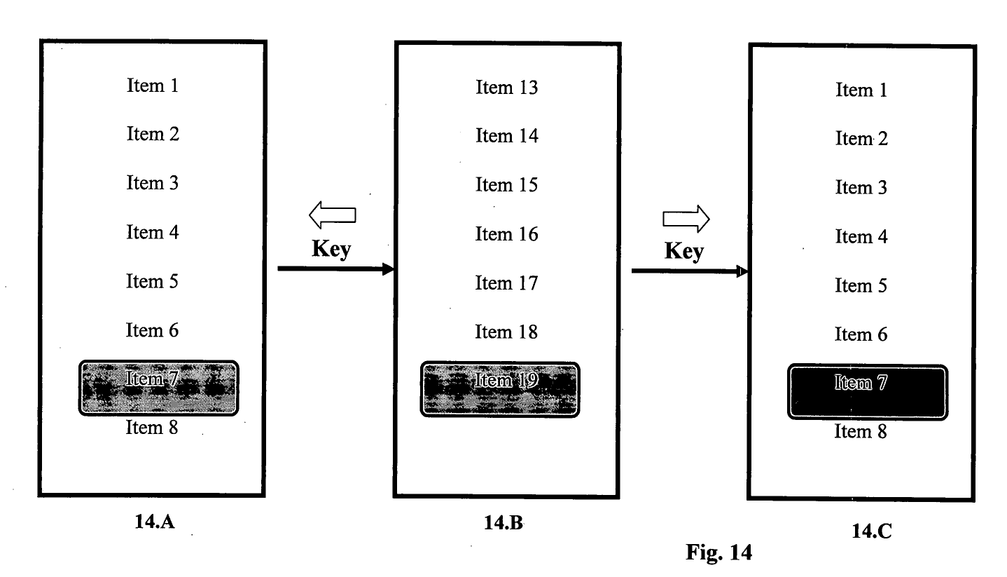

FIG. 14 shows an alternative way for the focus to act and for the sub-list to be displayed after [symbol] and [symbol] commands are applied when the item in the focus is near the start of the list;

FIG. 15 shows a flow chart for the operation of the user interface according to an example embodiment of the present invention.

Although the receiver can be an interactive television set, it can also be a receiver intended for receiving digital video data or one intended for connection to a bidirectional network, for example the Internet.

FIG. 1 is a block diagram of a digital television reception system. The receiver 1 of FIG. 1 is connected to a display screen 2 and an antenna which itself is connected to reception means 4 including: a tuner delivering a signal to a demodulator; the data received is corrected by a corrector circuit and transmitted to a demultiplexer. The demultiplexer includes a certain number of filters programmed by a central processing unit 3 depending on the various applications supported by the receiver 1. The filters correspond to identification data present in the header of packets of the demodulated signal.

The audio or video packets or sections filtered by the demultiplexer are stored in predefined areas of a data memory 9 for the attention of these applications. If necessary, the information is first decoded by a decoder circuit according to the user's rights, before being stored in the data memory 9. The receiver also has audio/video decoding logic 10 for the generation of audiovisual signals sent to the television screen 2, and possibly an interface 5 for communication with a high-speed local digital bus 6 for receiving audio/video data from a bidirectional network with storage in the memory 9. This network is for example an IEEE 1394 network. A memory 12 for executable programs contains the operating software of the receiver and specific applications. According to one example, the memory 12 contains at least five applications: an audio decoder, a video decoder, a teletext decoder, an access control suite and a user interface module called “Navigator”. For reasons of clarity of the diagram, the memory 12 is represented as a single block, but includes random access memory, read-only memory and reprogrammable persistent memory (for example “Flash” type memory).

The receiver also has an infra-red interface 7 for a remote control 8, said interface also being connected to the microprocessor 3. The remote control is equipped with [symbol] , [symbol] , [symbol] and [symbol] direction keys and “OK” and “Menu” keys, the functions of which we shall look at later.

A character generator 11, often called an OSD (On-Screen Display) circuit, is used to generate command or graphical menus related to the parameters of the receiver or to a particular application. The video signal generated by this character generator is multiplexed with one of the video signals from the reception means 4 or from the interface 5 with the digital network to a first SCART connector connected to the display screen 2.

The example embodiment is in the context of a digital television broadcast system, for example a DVB (Digital Video Broadcasting) system. The invention is not limited to this context, and can be applied to other environments in which ordered lists of items are presented to a user. The user interface has an electronic program guide sub-application. This guide enables the user to access descriptive information about the services as well as present and future events broadcast by these services. This information is derived from data also broadcast over the network. According to one example, this data is DVB service data, described in more detail in the document “EN 300 468 Digital Video Broadcasting; Specification for Service Information (SI) in DVB systems”. This document is published by ETSI (European Telecommunications Standards Institute). This data is transported in the multiplexed flow received by the receiver in packets having identifiers marked in a way that is known by the demultiplexer of the reception circuit 4 under the control of the microprocessor 3 and retrieved by the latter in a part of the data memory 9, for the user interface application to use. The data related to the electronic program guide is organized in tables describing in a hierarchical manner the objects of the flow. A description of the available services can be obtained in a known way particularly through a table labelled “SDT”. The hierarchy of the tables and the identifiers of the corresponding packets are described in the abovementioned DVB document. To extract packets containing the various tables, the demultiplexer filters are programmed accordingly.

First, the packets containing the services are grouped together to generate a list of services available at the receiver. This list is stored in a part 13 of the data memory 9. Since this list contains many items, the receiver displays sub-lists which are parts of the global list, the number of items in a sub-list being determined by the receiver. At the bottom of the screen, the receiver sends the video content of the current service that the user can select using the “program+” and “program−” keys. The number and/or the text identifier of the current service is displayed in a small window on the screen, independently of the displayed sub-lists.

FIG. 2 is a simplified diagram of two example screen displays showing the user interface generated by the device of FIG. 1 and presenting a sub-list. This screen display is commanded by a navigation feature in functions accessible through the “menu” key. The top screen shows a list of services numbered from 20 to 29, and service 29 is in the focus, that is if the user selects it via his remote control, he will be able to view the content broadcast. Suppose the user presses the [symbol] command; in the order of the list, it is service 30 which is then highlighted. The bottom screen display of FIG. 2 is displayed, and service 29 (not service 30) starts the list from the top. In this way, the user who sees this screen display and who does not know the history for arriving at this point therefore has information on the two services that can be accessed from the service having the focus. According to one improvement to this example embodiment, the displayed sub-list contains the group of 10 services for which the units digits start at “0” and end at “9”. However, if service 29 appears, 11 services are presented on this screen page. In this way, the rule to always display a group of 10 services, from one group of 10 to the next 10, is satisfied. The user who wants to quickly scan through the first few groups of 10 services to arrive at the one that interests him may navigate in groups of 10 services. For example, if he wants to reach service 125, he knows that he must press the page change key 12 times to view the sub-list presenting services 120 to 129.

FIG. 3 is a simplified diagram of two example screen displays when the user applies the [symbol] command from the screen display of FIG. 2. The top screen shows a list of services numbered from 29 to 39, and the user has positioned the focus on service 29 via the [symbol] command. Suppose the user presses the [symbol] command again; in the order of the list, it is service 28 which is then highlighted. The bottom screen display of FIG. 3 is displayed; service 29 starts the sub-list from the bottom and service 20 from the top. The displayed sub-list definitely includes 10 services for which the units digits start at 0 and end at 9. Thus, given this screen display, the user can therefore have information on the services accessible from the service in the focus: service 27 via the [symbol] command and service 29 via the [symbol] command.

FIG. 4 is a simplified diagram of two example screen displays when the user applies the [symbol] command from a standard screen display. The top screen shows a list of 10 services numbered from 20 to 29, and the user has placed service 20 in the focus using one or more [symbol] commands. Suppose the user presses the [symbol] command again; in the order of the list, it is service 19 which is then highlighted. The bottom screen display of FIG. 4 is displayed; service 20 starts the sub-list from the bottom and service 10 from the top, and therefore 11 services are displayed. The displayed sub-list definitely includes at least the 10 services for which the units digits start at 0 and end at 9. Thus, given this screen display, the user can therefore have information on the services accessible from the service in the focus: service 18 via the [symbol] command and service 20 via the [symbol] command.

FIG. 5 is a simplified diagram of two example screen displays showing navigation from a group of 10 services to another group of 10. The top screen shows a list of 10 services numbered from 20 to 29, and the user has placed service 25 in the focus using one or more [symbol] or [symbol] commands. Suppose the user presses the [symbol] command; then the navigator understands that the user wishes to display the next sub-list, increasing the service numbers by 10. The bottom screen display of FIG. 5 is then displayed, and service 30 starts the sub-list from the top and service 39 from the bottom; the service in the focus is the tenth service after service 25, that is service 35. Thus the user can navigate very quickly from pages of 10 services to pages of 10 services. The [symbol] command functions in the same way but in the reverse direction; after this command the service in the focus is the tenth service before the previously highlighted service.

FIG. 6 is a simplified diagram of two example screen displays showing the aspect of the navigation when the end of the list is reached. The top screen shows a list of 10 services numbered from 30 to 39, and the user has placed service 37 in the focus. Suppose the user presses the [symbol] command to skip to the next tenth service. But the total number of services is 45. The bottom screen display of FIG. 6 displayed after this command shows a sub-list starting with service 40 in accordance with the rule for displaying a sub-list starting from the service having “0” as its units digit. The service numbered 37+10=47 does not exist; therefore it is the service with nearest-number which is placed in the focus, that is service 45. If the user applies a [symbol] command to return to the previous sub-list, service 37 will be the one in the focus.

In one variant embodiment, the services are highlighted on the screen by an automatic scrolling process. The receiver highlights each item in the list for a determined length of time, for example three seconds. This automatic scrolling is described in French patent application FR 2 805 698 cited in the preamble. The variant applies the method of the invention by automatically displaying a new sub-list containing the previous item placed in the focus and the second item which did not appear previously. Thus the user no longer needs to press the navigation keys; he can wait until the focus positions itself on the desired service and then press the “OK” key. At any time, the user can reverse the scrolling direction by pressing the [symbol] or [symbol] key.

One visible improvement in FIG. 6 consists in associating a certain piece of information to the service identified in the list. This information concerns the fact that the service identified is not on the same satellite as the current service and therefore, if the user selects it then he must wait a certain period of time for the antenna to position itself correctly. During this operation, the screen is frozen except for the icon, which flashes. This information is useful for the user who could be wondering why his receiver is taking so long to present the service he has just selected. The test for whether or not a service belongs to the same package transmitted by a satellite is carried out by comparing the service data of the current service with that of the services in the list. If the information specifying the satellite is the same, there is no need to position the antenna, otherwise positioning will be necessary and the icon is displayed for this service. In the sub-lists of FIG. 6, services 30, 34, 37, 40 and 43 are not on the same satellite as that of the one of the current service.

The previous example embodiments show graphical menus including, in particular, a variable number of items. Other menus may also be envisaged for which the number of items displayed in a sub-list is fixed or less than a maximum value if the displayed list is incomplete.

FIG. 7 shows three example screen displays showing the user interface generated by the device of FIG. 1 for presenting on the screen a part of the list after navigation commands are applied. The left-hand part, labelled 7.A, represents the initial navigation display. The screen presents a sub-list of eight items labelled from top to bottom: “item 1” to “item 8”. On the figure, item 5 is the current item, and as such it has the focus. The central part, labelled B, represents the screen display after the [symbol] key is pressed. In a manner that is known per se, the focus is shifted onto the item beneath: item 6; this item is surrounded by two items visible on the screen (display 7.B). Conversely, if the user presses the [symbol] key, then the focus returns to the previous item: item 5 (display 7.C). This type of navigation is known per se, and is used to cause a focus to shift on a displayed sub-list of items; the current item may be activated, for example, using the “OK” key. If the list is displaying services, the activation action results in the visualization of the program broadcast by this service.

We shall now move onto another navigation instant which involves the invention according to an example embodiment. According to FIG. 8 display A, the interface displays the first eight items in the list, and item 7 (the second last item in the sub-list) has the focus. A [symbol] navigation command is applied which will shift the focus onto the last item in the sub-list: item 8. The user interface then modifies the displayed sub-list such that item 8 is made to appear surrounded by at least one item before and at least one item after. The sub-list containing items 7 to 14 is then displayed, with item 8 having the focus (display 13.B). Then the user presses the [symbol] key to shift the focus onto item 7 again. Since item 7 is currently at the top of the sub-list, a new sub-list is created and displayed containing items 1 to 8; item 7 with the focus is displayed clearly surrounded by items 6 and 8 (display 13.B).

FIG. 9 presents three examples displays showing sub-lists when the item in the focus nears and reaches the end of the list. The list has a total of nine items and the user interface displays only eight items in one menu. The focus is placed on the second last item in the sub-list (display 9.A). The user applies a [symbol] command which will shift the focus onto the last item in the list: item 8. The user interface then modifies the displayed sub-list such that item 8 is made to appear surrounded by at least one item before and at least one item after (display 9.B). Next the user presses the [symbol] key again; item 9 is then selected (display 9.C). Since this is the last in the list, it cannot be surrounded by having an item placed after it, and the empty space that then appears informs the user that item 9 is the last in the list. Any further [symbol] command does not modify the display.

FIG. 10 presents three examples displays showing sub-lists when the item in the focus nears the end of the list. The list has eight items and the user interface can display all of them. The focus is placed on item 7 before the last in the list (display 10.A). The user applies a [symbol] command which will shift the focus onto the last item in the list: item 8. Since this is the last item, it cannot be surrounded by having a next item, and there would therefore be no need to modify the displayed list by the shifting the focus onto item 8. But in that case, the user is unable to know that item 8 is the last item in the list. To notify the user of this fact, the user interface advantageously modifies the sub-list of display 10.A to make item 8 appear preceded by item 7 and followed by an empty space showing the user that there are no items after (display 10.B). Then the user presses the [symbol] key to return to item 7. The same sub-list as in display 10.A appears, item 7 clearly being surrounded by items 6 and 8 (display 10.C).

FIG. 11 presents three examples displays showing sub-lists when the item in the focus nears and reaches the start of the list. The focus is placed on the second item in the sub-list (display 11.A). The user applies a [symbol] command which will shift the focus onto the first item in the list: item 8 (display 11.B). Since this is the first in the list, it cannot be surrounded by having an item placed before it. Any further [symbol] command does not modify the display.

FIG. 12 presents three example displays when navigation is carried out from sub-list to sub-list. According to display 12.A, the interface displays the first eight items in the list, and item 7 (before the last item in the sub-list) has the focus. A [symbol] navigation command is applied and will display the next sub-list. The interface then displays the list of items 7 to 14; item 13 which is the second last item in the sub-list has the focus (display 12.B). The user then wishes to return to a proceeding sub-list; he presses the [symbol] key and display 12.A re-appears (display 12.C). In general, sub-list to sub-list navigation does not modify the position of the focus in the sub-list, but rather the contents of the sub-list.

FIG. 13 presents three example displays showing sub-lists according to one variant when the item in the focus nears the end of the list. In the example, the list has 19 items and the focus is placed on the first item in the list: item 1. Being the first one, the item in the focus is not surrounded by having an item before it, and as such the user knows that it is first item in the list (display 13.A). The user applies a [symbol] command. According to one variant embodiment, the focus does not remain locked on the first item, but rather a new list is displayed showing the last items in the list. Since the last item in the list has the focus, it cannot be surrounded by having an item placed after it, and the empty space appearing after it informs the user that item 19 is the last in the list (display 13.B). Next the user presses the [symbol] key; the user interface makes item 1 and the seven items after it re-appear (display 13.C).

The same behaviour as for the abovementioned variant occurs when the command applied results in sub-list to sub-list jumps near the start or the end of the list. In the example described by FIG. 14, the list has 19 items and the focus is placed on one item in the first sub-list which starts with item 1 (display 14.A). The user applies a [symbol] command. According to the variant embodiment, the focus does not remain locked on the first sub-list, but rather a new list is displayed showing the last items in the list (display 14.B). Items 13 to 19 are displayed. Since item 19 has the focus, it cannot be surrounded by having an item placed after it, and the empty space appearing after it informs the user that item 19 is definitely the last in the list (display 14.B). Next the user presses the [symbol] key; the user interface makes item 1 and the seven items after it re-appear (display 14.C).

The flow chart of FIG. 15 shows the steps executed by the user interface for displaying navigation menus. At step 15.1, a first sub-list is displayed, with an item being highlighted. At step 15.2, the user applies a navigation command to change the current item and to select an item adjoining the current item. The user interface will then determine whether the new current item is surrounded by at least two items, that is at least one item before and one item according to the navigation directions (step 15.3). If the new current item is not surrounded by at least two items (except if it is the first or the last item in the list), then a new list is generated and displayed (step 15.4). If the new current item is the first in the previous sub-list, it occurs as the second last item in the new sub-list. If the new current item is the last in the previous sub-list, it occurs as the second item in the new sub-list. In all the cases, the new current item is highlighted graphically (step 15.5).

The presentation of lists and sub-lists of services broadcast in the context of digital television must be considered only as one example application of the present invention. The present invention applies to all lists of items that can be displayed on a screen or any other viewing means, in particular lists of audiovisual programs, lists of sources for obtaining documents, lists of functions accessible from a terminal, etc.

In one improvement, the minimum number of items that surround, before and after, the item having the focus in the displayed sub-list is programmable. For example, if the screen is large enough to display 21 item identifiers, the interface may require that at least three items be displayed before and after the item having the focus. In that case, suppose the displayed items are numbered sequentially from 1 to 21; navigation on items 4 to 18 takes place without changing the sub-list of displayed items. The user interface hence includes a step for entering the number of items surrounding the current item. The items cannot be displayed if the new current item is the first or the last item in the list, or very close to the first or last item in the list.

The present invention also applies when the highlighted item is displayed in a grid of items. After applying a navigation command to change the current item and select an item adjoining the current item, the user interface tests whether the new item is surrounded by four displayed items, that is, if it is not located at the edge of the grid. If it is, a new sub-list of items is generated and displayed, in which the new current item is surrounded by at least one item in all the navigation directions.

Although the example embodiment presented above concerns lists of services, the invention applies also to lists of other items, such as events or even audio, video or data files.

1. A method for navigating on items displayed on displaying means, including a first step for generating and displaying a first sub-list of items extracted from a list of items, the current sub-list item being highlighted graphically;
a second step for generating and displaying a second sub-list of items, said step being activated when, after a navigation command is applied, the new current item is located at the first or last position of the first sub-list, the second sub-list presenting the new current item surrounded by at least two items.
wherein, when the new current item is the last item in the list, the second step causes a second sub-list to appear with a space devoid of items after the new current item.

2. (canceled)

3. (canceled)

4. The navigation method as claimed in any claim 1, wherein the first and second sub-lists are displayed in a grid, and when the new current item is located on the edge of the grid of the first sub-list, the second sub-list presents the new item surrounded by at least four items located in the four navigation directions, and when the new current item is the last item in the list, it then appears surrounded with at least one space devoid of items.

5. The navigation method as claimed in claim 1, wherein it includes a step for entering the number of items that surround the new current item.

6. The navigation method as claimed in claim 1, wherein the second step for generating and displaying a second sub-list occurs after a determined period of time, the items in the list being successively highlighted by the receiver according to the defined order.

7. (canceled)

8. (canceled)

9. The navigation method as claimed in claim 7, wherein it includes a step for displaying an indicator associated with displayed services or events in the sub-lists, the presence of the indicator indicating that the associated service or event is not broadcast by the same satellite as the currently selected channel.

10. An audiovisual receiver including means for applying navigation commands, and display means for displaying sub-lists of items extracted from a list of items, graphically highlighting a first item referred to as “current”, activated after a navigation command is applied, if the new current item is located at the first or last position of the previous sub-list, then the new sub-list displayed by the display means presents the new current item surrounded by at least two items; wherein when the new current item is the last item in the list, then the display means causes the new sub-list to appear with a space devoid of items after the new current item.

11. (canceled)

12. The audiovisual terminal as claimed in claim 10, wherein it includes display means for displaying an indicator associated with displayed services or events in the sub-lists, the display of the indicator indicating that the associated service or event is not broadcast by the same satellite as the currently selected channel.

13. The audiovisual receiver as claimed in claim 10, wherein the sub-lists are displayed in a grid, and when the new current item is located on the edge of the grid of the preceding sub-list, the new sub-list presents the new item surrounded by at least four items located in the four navigation directions, and when the new current item is the last item in the list, it then appears surrounded by at least one space devoid of items.

14. The audiovisual receiver as claimed in claim 10, wherein it includes means for entering a number of items that surround the new current item, the display means taking this number into account for displaying this number of items around the new current item.

15. The audiovisual receiver as claimed in claim 10, wherein the display means displays a second sub-list after a determined period of time, the items in the list being successively highlighted by the receiver according to the defined order.
